(19) United States
(12) Patent Application Publication
(10) Pub. No.: US 2013/0110704 A1
(43) Pub. Date: May 2, 2013

(54) COMPUTERIZED SYSTEM AND METHOD FACILITATING QUALIFICATION FOR AND ACQUISITION OF FUNDING FOR COMMERCIAL REAL ESTATE PROJECTS

(71) Applicants: Leonardo Padron, Miami, FL (US); Guillermo Lopez, Colorado Springs, CO (US)

(72) Inventors: Leonardo Padron, Miami, FL (US); Guillermo Lopez, Colorado Springs, CO (US)

(73) Assignee: NEBO CAPITAL GROUP, INC., Colorado Springs, CO (US)

(21) Appl. No.: 13/567,538

(22) Filed: Aug. 6, 2012

Related U.S. Application Data
(60) Provisional application No. 61/515,405, filed on Aug. 5, 2011.

(51) Int. Cl. G06Q 40/02; G06Q 50/16

(52) U.S. Cl. CPC G06Q 40/025; G06Q 50/16
USPC 705/38

(57) ABSTRACT

A computerized system and method which facilitates qualification and acquisition of funding for commercial real estate projects is provided. A user accesses a server hosting a website. Client data and commercial real estate project data are inputted. This data is compared to financing programs contained within an electronic database. Financing programs for which the client prequalifies are electronically displayed. After selecting a prequalified financing program, an electronic commercial real estate financing application is generated and electronic documents are either created by the user via the server or uploaded to the server. The electronic commercial financing application is submitted to at least one of the prequalified financing programs.

### BACKGROUND OF THE INVENTION

The present invention generally relates to funding of commercial projects. More particularly, the present invention relates to a computerized system and method which facilitates commercial real estate transactions.

Since the crash of the financial markets in 2008, there has generally been a lack of access to capital. Business owners have found it difficult to finance their business, and developers have been turned down by their trusted banks. Investors, even those with excellent credit, have been unable to finance their properties in this financial climate. Many times, projects are mothballed for lack of interest on the part of banks and traditional lenders.

Even before the financial crisis, it was a very time consuming and tedious task for a user or a borrower to find a commercial loan or other financing that fit their specific parameters. Currently, a broker must perform the searching required for matching a borrower and a suitable loan. The broker has to expend considerable effort each time a new borrower is found to make sure a suitable loan is found. The broker does not always have the time and experience to find the best loan available to the borrower as his resources and information are limited. Moreover, brokers often do not have accessible to them information related to non-traditional or non-banking institutions or capital funds.

Individual borrowers contemplating the purchase or acquisition of a commercial property (such as a multi-family housing unit, office space, land to be developed, etc.) may not have a relationship with a broker or have past experience in obtaining commercial financing. The individual may not be familiar with the calculations and ratios which are required to obtain such financing. Moreover, the borrower may not know if the price is fair or if the anticipated income generated from the property will be sufficient to afford the property. Furthermore, the borrower and/or broker may not be able to obtain a conventional loan through a bank or other financial institution, but may be able to obtain other financing which is often difficult to find. As mentioned above, even if the borrower is able to qualify for financing through a traditional bank or financial institution, the borrower or his/her broker must prequalify through each institution and for each loan, which is an arduous task which requires a great deal of information and documents for each loan applied for, before being approved for a loan or selecting amongst the approved loans.

Accordingly, there is a need for a way to shorten the time and effort required for a user to find a suitable loan that meets a lender's guidelines for both the property as well as the borrower. Additionally, there is a need to compile the available loans in the marketplace into one database that can easily be accessible. Also, many are unaware of what lenders are looking for in determining if a property is a suitable candidate. Calculations and ratios are required and many are not familiar with what those exactly are or how they are determined. The present invention fulfills these needs and provides other related advantages.

### SUMMARY OF THE INVENTION

The present invention resides in a computerized system and method for facilitating prequalification, qualification for and acquisition of funding for commercial real estate projects. The present invention shortens the time and effort required for a user to find a suitable loan that meets a lender's or financier's guidelines for both the property as well as the borrower. The present invention includes many analytical tools for use by the user, a database of varying types of commercial real estate finance programs, and enables the creation, uploading, and access of various documents for use by the client, broker or underwriter, and representative of the finance program.

A computer is used to access a server-hosted website. Client data is inputted using the computer. Commercial real estate project data is also inputted using the computer. This data includes property type, appraised value, purchase price, finance amount and down payment data.

The system of the invention accesses an electronic database of financing programs. Typically, a plurality of commercial real estate financing types is displayed, and a type of commercial real estate financing is selected by the user. Prequalification of the client and commercial real estate project is electronically determined by comparing requirements of the financing programs to the inputted client and commercial project data.

At least one financing program for which the client prequalifies is electronically displayed. This includes listing financing rates and terms for each prequalified financing program. The user utilizes the computer to select a prequalified financing program.

An electronic commercial real estate financing application is created via the website, which includes inputting commercial financing application data comprising commercial property data, borrower data, and financial data into an electronic template of the financing application. The system of the present invention prompts the client or broker to upload particular documents required for the commercial financing application. The financial documents are electronically uploaded in order to accompany the financing application. These uploaded documents are electronically saved for downloading or viewing by a finance program representative, a broker or underwriter, or even the client.

In a particularly preferred embodiment of the present invention, the client is allowed to submit the financing application directly to a selected financing program for which the client has prequalified via the website. Alternatively, the client may use a website representative to serve as a broker or underwriter to submit and process the financing application with the selected finance program for which the client is prequalified. Yet another option is for the client to use a third-party broker or underwriter, which may or may not be referred to the client by the website representative, to submit and process the financing application for the selected finance program for which the client has prequalified.

During the processing of the finance application, electronically generated messages relating to the financing application, which may be generated by the client, broker and/or finance program representative, are displayed for viewing and if necessary response via windows or web pages of the website. A user may view an electronically displayed transaction overview page or window, which includes borrower data, commercial property data, electronic messages generated by the client, broker or finance program representative, electronic financing application, uploaded and electronically saved documents, and finance program data. The client, broker or financial representative may also be able to view an electronically displayed transaction status page or window, which includes information relating to the status of each submitted commercial financing application, including the step of displaying the finance program name, finance program contact information, finance program geographic location, transaction status, and financing application start date.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIGS. 1A-1C are a flowchart depicting the steps generally taken in accordance with the present invention;

FIG. 2 is a screenshot of an exemplary online mortgage prequalification process embodying the present invention;

FIG. 3 is a screenshot of the exemplary embodiment of FIG. 1 now showing potential loans;

FIG. 4 is a screenshot of the exemplary embodiment of FIG. 1 now prompting for income and expense information, to determine if the necessary debt service coverage ratio has been attained;

FIG. 5 is a screenshot generated in accordance with the present invention, illustrating prompting of selection of document types, entities, property types, transactions and users, in accordance with the present invention;

FIG. 6 is a screenshot used in accordance with the present invention, illustrating active transactions, including finance program data and transaction status data in accordance with the present invention; and

FIGS. 7A-7C are screenshots generated in accordance with the present invention, illustrating overview and status data relating to an in-progress finance application.

### DETAILED DESCRIPTION OF THE PREFERRED EMBODIMENTS

As more fully described herein, the present invention is concerned with a computerized system and method for facilitating qualification for and acquisition of funding for commercial real estate projects. The invention comprises computerized software and hardware which provide an online platform which empowers investors, developers, entrepreneurs, borrowers, brokers and real estate professionals to solicit financing. The system of the present invention quickly consolidates analytics, demographics, and user performance to effectively reach various types of commercial real estate finance programs, including private investors, life insurance companies, commercial bankers, credit unions, family funds, hedge funds, pension funds, etc.

As described above, sources of capital for commercial lending in the current global market conditions can be an intimidating endeavor. Finding loans or investors who are willing to buy into the commercial project can also be a complex endeavor. However, there are many different types of financial programs from traditional banks and commercial lending institutions to different types of commercial financing opportunities, which include private investors, life insurance companies, hedge funds, pension funds, etc. The present invention, in part, brings these various types of commercial financing together with those seeking financing for their commercial real estate projects.

The present invention, however, does not stop at the match between capital seeker and capital provider. The present invention also follows the transaction to completion, by providing prequalification processing, underwriting and servicing of the loan or other financing. The system's web-based data feed and algorithms offer real-time solutions and valuable financial tools for all parties involved. The services provided in accordance with the present invention include analytics, evaluation, education, processing, underwriting, financing and traffic enhancers which facilitate the transaction from beginning to end.

In fact, the system and method of the present invention enables one to analyze a commercial transaction in just minutes, and provide the best loan or financing programs available for borrowers with a list of initial required documentation, which can either be created via the website or uploaded to the website, as will be more fully described herein. The system of the present invention then allows the client or borrower to directly apply and qualify for the loan or financing program directly through the finance program, use their own broker or underwriter or one referred to by the host of the website, or use the host of the website to process the transaction and act as the borrower's broker and underwriter.

The system and method of the present invention enables a user or client (referred to herein as either the borrower or broker) to search for capital for his or her project based upon country, loan amount, and type of finance program. Global capital can be accessed for debt, business, equity and project financing. This enables the client to connect directly with lenders.

The present invention also includes various analytical tools which enable the client to access statistics that are specific to the commercial real estate project, regarding demographics, market conditions, capital and programs. These tools can also be used to execute the cash flow analysis and create proformas. These tools can also provide brokers and professionals the ability to create powerful presentations, financial proformas, projections, etc.

The present invention enables the client or user (any of the borrower, broker, underwriter or representative of any party) to prequalify a transaction and determine the financing rate, terms, loan-to-value ratios, and payment nearly instantly. Data can be entered and documents created, or documents safely and securely uploaded to an electronic storage database associated with the website for review and use in the financing application process. In the event that the borrower decides not to use the loan processing and underwriting services of the host of the website, his or her broker or professional is essentially provided with a virtual staff by utilizing the system and method of the present invention. Such professionals are provided with tools to efficiently monitor and manage their personal pipelines of financing applications. The present invention also provides prequalified leads to brokers and professionals as both a service to these brokers and professionals as well as the potential borrower.

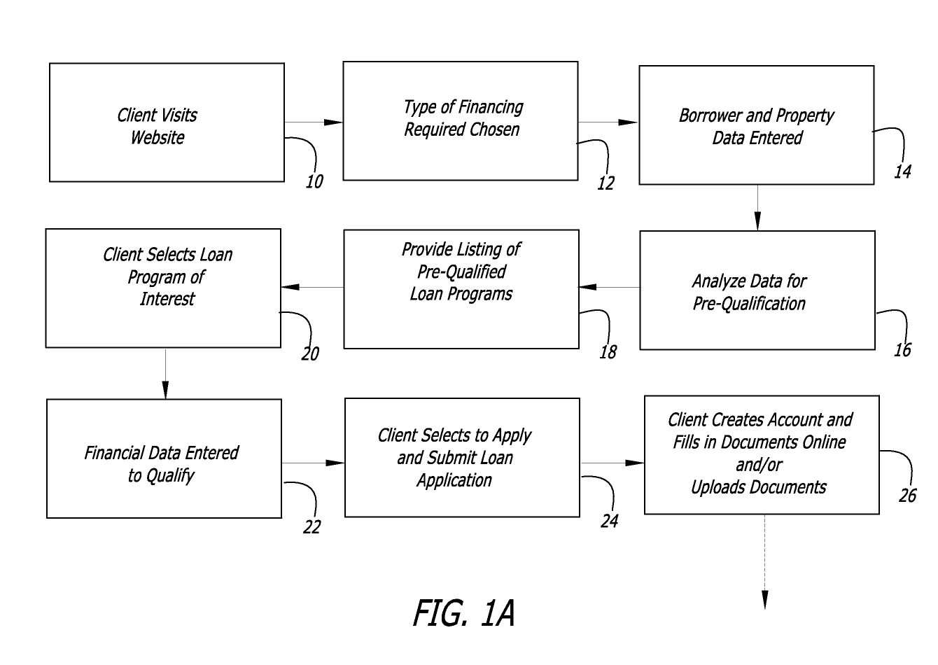

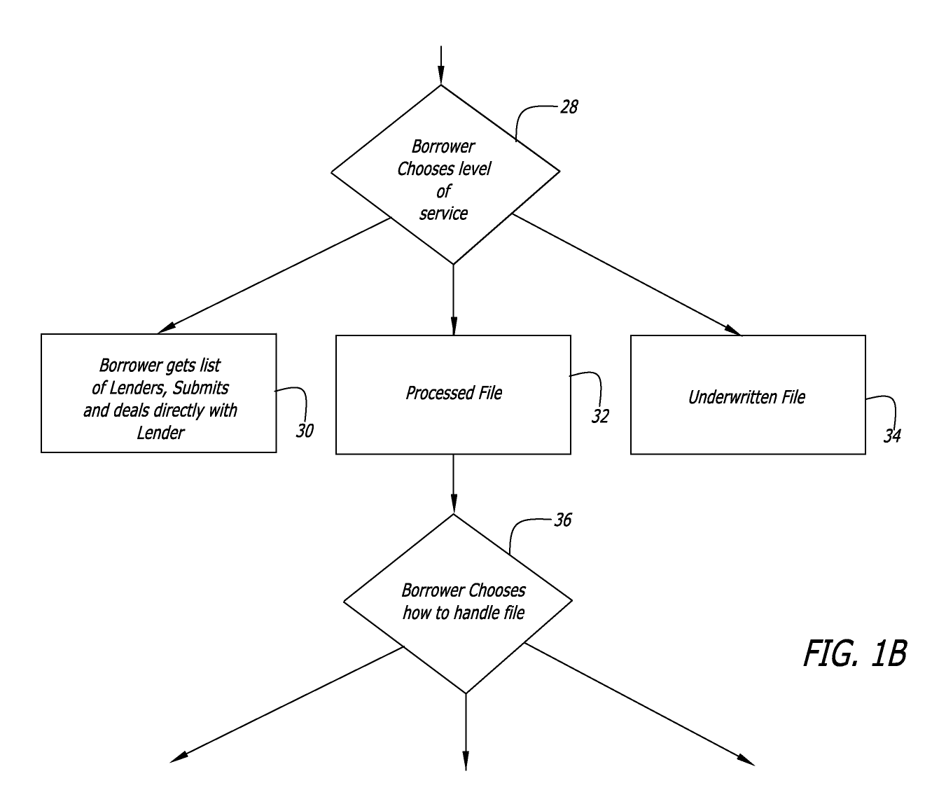

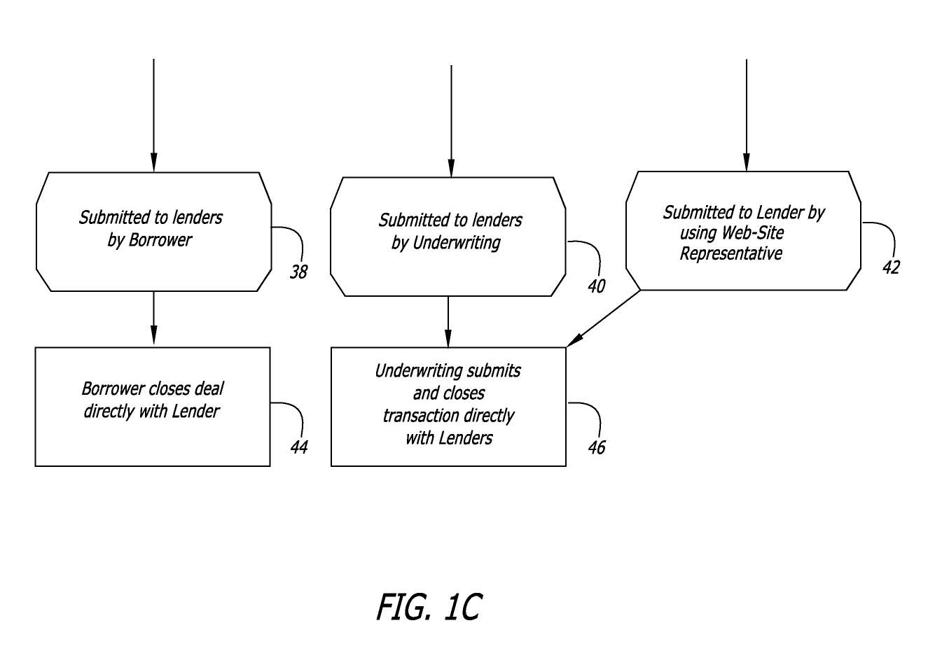

As shown in the accompanying drawings, for purposes of illustration, FIG. 1 is a flowchart depicting the steps generally taken in accordance with the present invention. Typically, a borrower or his or her broker visits a website enabled by and embodying the present invention (10). It is contemplated by the present invention that access to the website and its tools and information may be by means of a paid subscription, including a one-time use subscription, a monthly subscription, an annual subscription, etc. In this case, the user (client, broker, or other representative) will create at a minimum a login name and password, and possibly additional registration information before gaining access to the website.

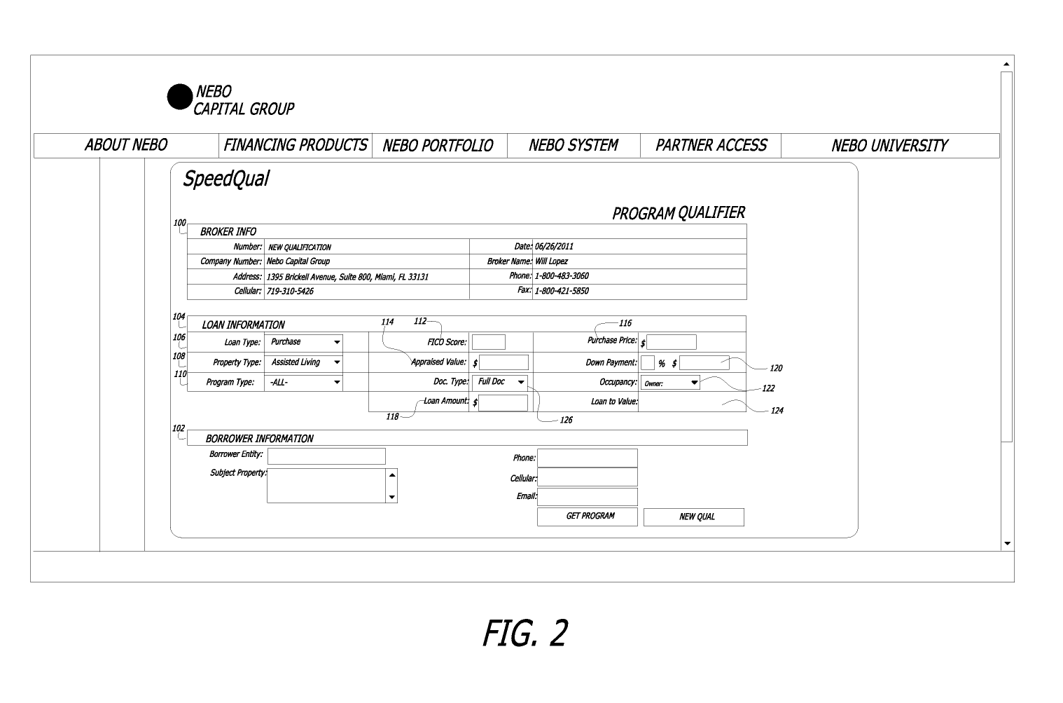

When seeking financing for a new commercial real estate project, refinancing or the like, the user is provided a webpage, such as that illustrated in FIG. 2. The broker or representative is prompted to provide information relating to the broker (100), including the company's name, address, telephone number, broker name, fax number, etc., and the date upon which this information is entered is either input by the broker/representative or automatically generated. The broker can also enter information regarding the borrower, including borrower entity, name, phone number, email or fax information, and information related to the commercial real estate property (102). In the instance where the borrower is visiting the website without a broker or other representation, the borrower will enter only his or her information.

With continuing reference to FIG. 2, the system of the present invention prompts the user (broker or borrower) to enter information concerning the loan or other financing sought (104). This includes selecting a loan type, which is presented by means of a drop-down list to the user, and includes purchase, refinance, or refinance cash-out. A property type drop-down list is also provided and the user is able to select a property type, including assisted living and senior housing projects, auto repair, auto mall dealerships, daycare, energy projects, condominiums, funeral homes, hotels, casino, industrial, land acquisition and construction, malls, medicals, multi-family, mixed use, office, restaurant, retail, schools, storage, shopping center, strip malls, student housing, warehouse, and the like. The user is also able to select program type from a drop-down menu, including blanket loans, bridge, CMBS conduit, construction loans, conventional, foreign/national, FHA-HUD, hard money, healthcare financing, international loans, JV capital, rehab loans, SBA 504 or A7, and the like. The finance program types can be varied depending upon the finance programs which are available to the client and which are contained within a database of the system.

As further information typically required to prequalify the client, the user is prompted to enter the borrower's credit or FICO score (112). The appraised value (114), the purchase price (116), and the loan amount sought (118) for the commercial real estate project is also prompted to be provided. The down payment as a percentage and/or dollar amount (120) is also requested, as well as the occupancy (122) to the extent this is applicable. The system will automatically calculate the loan-to-value ratio or percentage (124). Although the vast majority of loan qualifications require full documentation, in some instances partial documentation may be allowed, and the user is allowed to select the document type (126) as either full document, easy document, stated, etc.

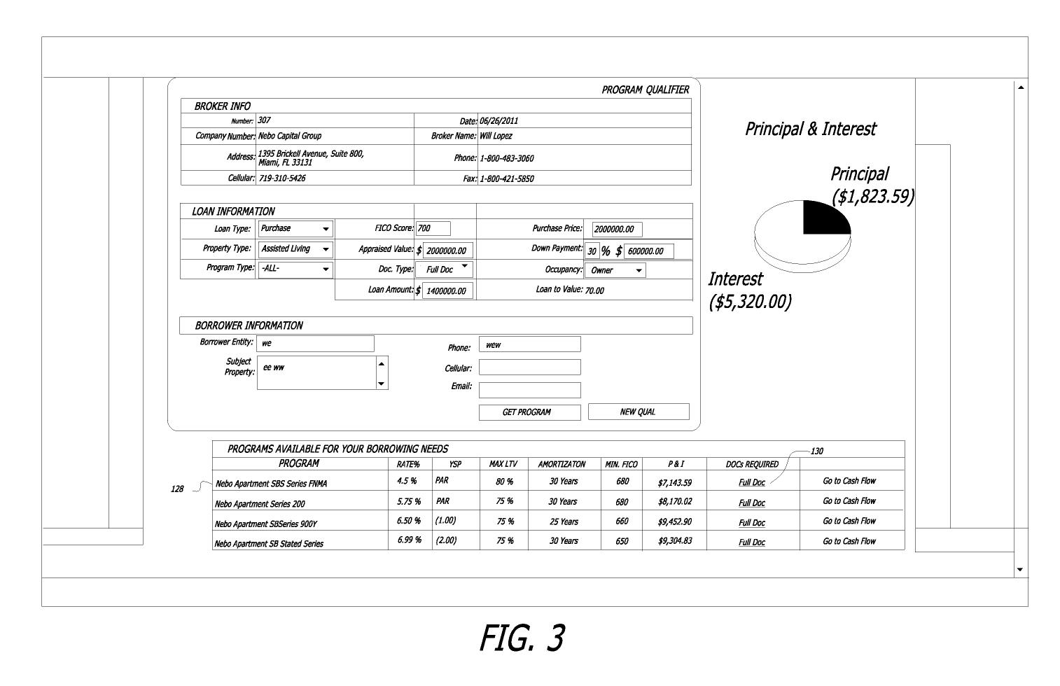

Upon inputting the necessary client data and commercial real estate project data, such as that illustrated and described with respect to the online screen of FIG. 2, the present invention will automatically prequalify the client and commercial real estate project by comparing the inputted information to an electronic database containing financing programs. The present invention creates or otherwise accesses an electronic database having a plurality of financing programs, the financing programs including various individual requirements in order to be eligible to be considered for that financing program. These individual requirements for each financing program are automatically and electronically compared by the algorithm and system of the present invention based upon the information inputted regarding the borrower and commercial real estate project to determine if the requirements of a given financing program have been met. If so, as illustrated in FIG. 3, a listing of the one or more financing programs for which the borrower and commercial real estate project have prequalified for is provided (128). It will be seen from FIG. 3 that the finance program name, interest rate, yield spread premium, maximum loan-to-value ratio, amortization, minimum credit FICO score, monthly principal and interest are listed. The user can highlight or otherwise select and open additional information regarding the finance program, such as by clicking on the finance program or attachment using the computer mouse or touch screen display, etc. The user is then presented with various options as far as rate, amortization, monthly payment, etc. which enables the user (client or broker) to determine the commercial real estate financing program which best suits that borrower's needs.

With reference again to FIG. 1, after selecting the type of financing (12) and entering the borrower and properly data (14), the data is analyzed for prequalification (16), and a listing of prequalified loan programs (18) is provided, as described above with respect to FIGS. 2 and 3. The user (borrower or broker) then selects the one or more loan programs of interest (20). At this point, the borrower is simply prequalified for that particular financing program based upon the information provided. The borrower, either on his or her own or by means of a representative which may include an independent broker or a representative of the website, must actually qualify for the financing, such as by completing a loan application, providing additional information and documents, etc. Financing program requirements and terms (including rate, maximum loan-to-value ratio, amortization, minimum FICO score, etc.) often change over time. Moreover, a closer analysis and evaluation of the borrower's documents and property may either alter the terms or render the borrower and commercial real estate property ineligible for the financing after the loan application has been more thoroughly reviewed and processed.

Additional financial data is entered into the computer, as prompted, in order to seek qualification for the loan (22). As shown in FIG. 3, an aspect of the present invention is that for each finance program listed (128), the user can click and select the documents required (130), in order to see a listing of all of the documents which that finance program requires as part of the application and qualification process. In accordance with the present invention, templates may be provided for the user to input additional information via his or her computer in order to create an electronic commercial real estate financing application, and in some instances one or more of the documents required for qualification and financing application purposes. In other instances, the user may need to upload documents which have been previously scanned or are otherwise in electronic format. For example, the finance program may require two years of tax forms in order to process the application and determine qualification. The user would need to upload the scanned or electronic version of the two years of tax forms.

In accordance with the present invention, electronic documents can be uploaded directly to the website. This entails the user creating an account and either filling out the documents online and/or uploading the documents (26), as illustrated in FIG. 1. Directly uploading the documents to the server and website can be done in a much more secure fashion than emailing the documents, for example, and is much faster and more convenient than mailing hard copies. Producing the documents in electronic form also enables them to be saved and viewed not only by the borrower, but the broker, underwriter, representative of the financing program, etc. as needed. As such, the uploaded and created documents are available to the processing and underwriting departments as needed as these individuals can access the website and select the document, which is retrieved from data storage associated with the website. This may also eliminate or reduce the redundancy in providing the same documents multiple times to multiple financing programs, as is currently the case.

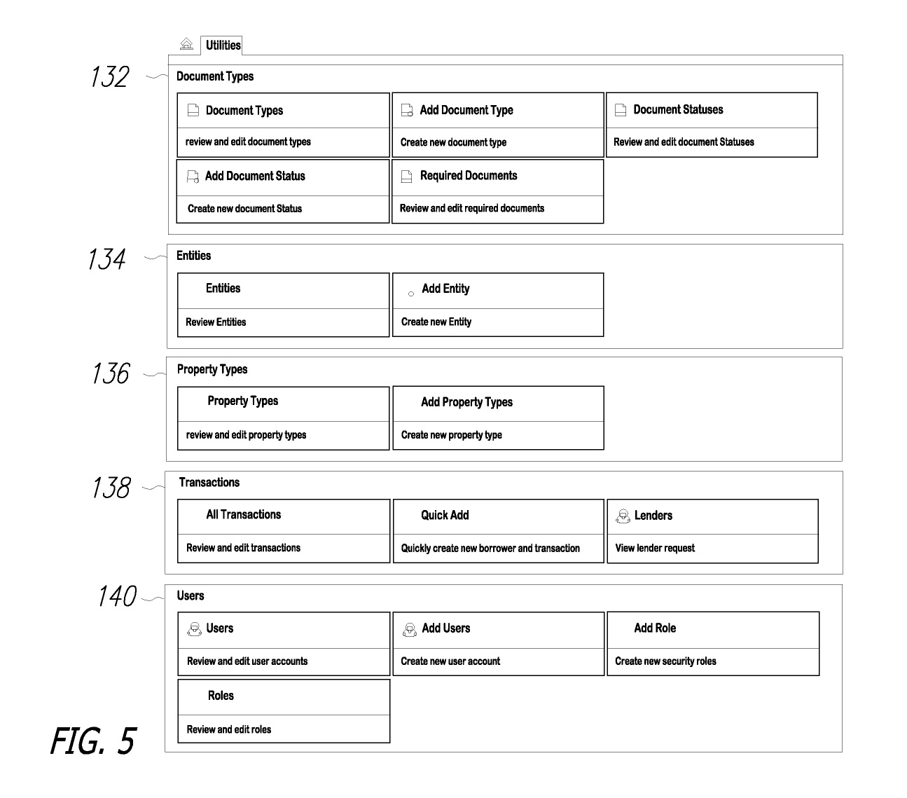

With reference to FIG. 5, a website screen is illustrated showing various functionality of the system of the present invention. Under a “document types” window or screen, various document types which have been uploaded or created can be reviewed and edited as necessary. Documents may also be created or added, and the status of documents can be viewed. Those processing the application can add to the document status and input additional required documents or those documents which have not yet been submitted. An entity screen (134) is provided for showing the client entity information, and additional entities or owners or applicants can be added. This can be used, for example, by a broker which has more than one borrower/client applying for loans at the same time. In this manner, the broker can select the entity or client files desired. There is also a “property types” window or page (136) which enables the review and editing of property types, or the creation of new property types. A “transactions” window or page (138) enables the review and editing of all transactions, and enables the creation of new borrower and transaction as well as lender requests. A “users” window or page (140) enables the review and editing of user accounts, the creation of new user accounts, and new security roles. This may be used, for example, when multiple brokers from a single entity are accessing this information and have separate accounts.

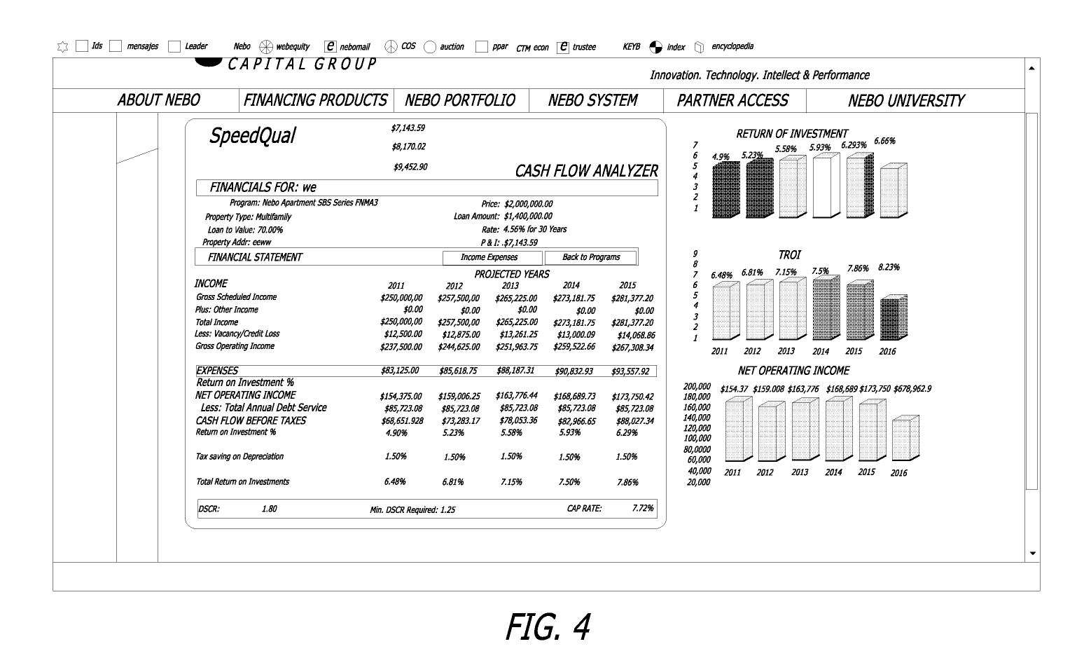

With reference now to FIG. 4, as mentioned above, the present invention provides many tools for use by the client, broker, etc. One such tool is a cash flow analyzer which takes information relating to the client as well as the commercial real estate project and a selected loan type (such as that selected from FIG. 3) and projects income either by estimation and/or user input as well as expenses and calculates net operating income and other factors. Some of this information must be entered in by the user. However, in other cases the system of the present invention can insert estimates based upon the property type, location, etc. For example, the industry standard for vacancy of a multi-residential property is 5% in a good economy. Expenses for a multi-family unit can also be estimated, as apartment expenses typically range from 32%-42% of the effective income, yielding a reasonable estimate of 38% expenses for such commercial apartments based upon the effective income. However, properties with triple net leases can estimate their expenses at 12% of the effective income.

As shown in the right-hand side of the screen of FIG. 4, bar graphs illustrating over time the return in investment, true return of investment, and net operating income can be calculated and visually displayed. In this manner, the client or broker can visually gauge and determine in a very quick manner these aspects of the investment. Of course, the representative of the financing programs can also utilize this information to determine if the financing program considers the investment safe and profitable in order to loan or otherwise finance the project.

One of the characteristics which the finance program considers before qualifying the financing for the commercial real estate project is the debt service coverage ratio (DSCR), which is essentially the borrower's ability to support the new debt. This entails the calculation of the net operating income of the property divided by the annual payment. The net operating income is typically the income from an income property less all of the operating expenses other than the mortgage or financing payment. For example, scheduled rents in an apartment complex amounting to $150,000 per year, less a 5% vacancy and collection costs of $7,500, yields an effective gross income of $142,500. Operating expenses, including real estate taxes, repairs, insurance, maintenance, utilities, etc. are deducted. The resulting net operating income is then divided by the mortgage or financing payments to yield the DSCR ratio or percentage. Typically, finance programs will have a minimum DSCR requirement, such as the 1.25 illustrated in FIG. 4. If, after considering all of the income and expense information provided, the DSCR exceeds the minimum, this is an indication of the potential to qualify for the loan. Thus, the borrower or broker may input this data and analyze the cash flow to ensure that the minimum DSCR for a given loan program has been met before paying to apply for that loan and taking the time to supply information, documents, etc. to that finance program.

With reference again to FIG. 1, in accordance with the present invention the borrower or client is able to choose the level of service provided to him or her (28). This includes the borrower obtaining the list of lenders and submitting and directly dealing with the lender himself or herself (30), or choosing to have the file processed (32) or underwritten (34) by another. The borrower is allowed to choose how to handle the file (36), including the borrower submitting the loan application, information, and documents directly to the lenders/finance programs (38). Alternatively, the borrower may elect to submit the application, documents, etc. by underwriting (40) or by means of a representative of the host of the website (42). In the case where the borrower submits directly to the lenders, the borrower closes the deal directly with the lender or financing program (44). However, in the case where the borrower utilizes a broker/underwriter or a representative of the website to service the broker/underwriter, the underwriting submits and closes the transaction directly with the lenders/financing programs (46).

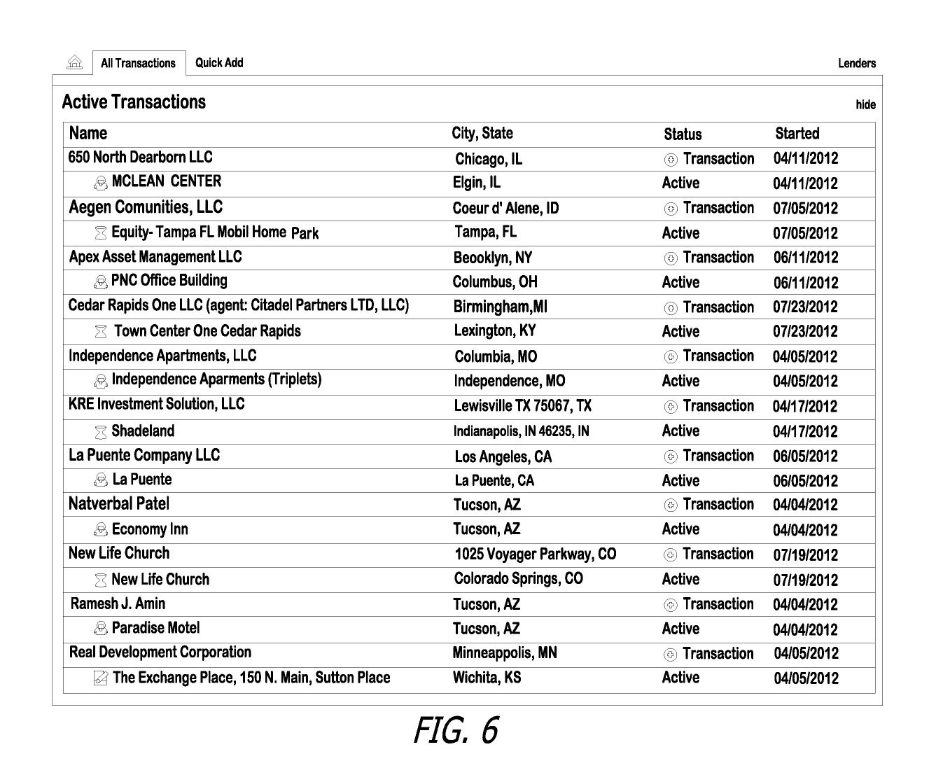

With reference now to FIG. 6, a window or screen of the website is shown generated in accordance with the present invention which illustrates the active transactions for borrowers and commercial real estate projects. Loan applications have been submitted to multiple lenders/finance programs, and the name of the finance programs is provided in a left column, the city and state where the finance program is located is illustrated in another column, the date when the application process was started is shown in the far right column, and the transaction status is illustrated in yet another column. In some instances, the financing program is only able to make loans and otherwise finance within a limited geographic area, such as within a given state of the United States.

In the Active Transactions screen illustrated in FIG. 6, a broker can view the active transactions which he or she has for multiple borrowers/clients and the financing program(s) which have been applied for that particular client. For example, the broker is representing a borrower for the “Mclean Center”, and a commercial real estate financing application and related information and documents has been submitted to a financing program in Illinois. The broker represents another borrower with respect to a mobile home park in Florida, and the loan application has been submitted to a finance program in Idaho. The broker can select the “transaction” link to open additional pages where the status of the transaction will be illustrated in more detail. The broker knows that the transaction is active, and not closed, by means of a designation such as “active”, a green symbol as opposed to a red symbol, etc.

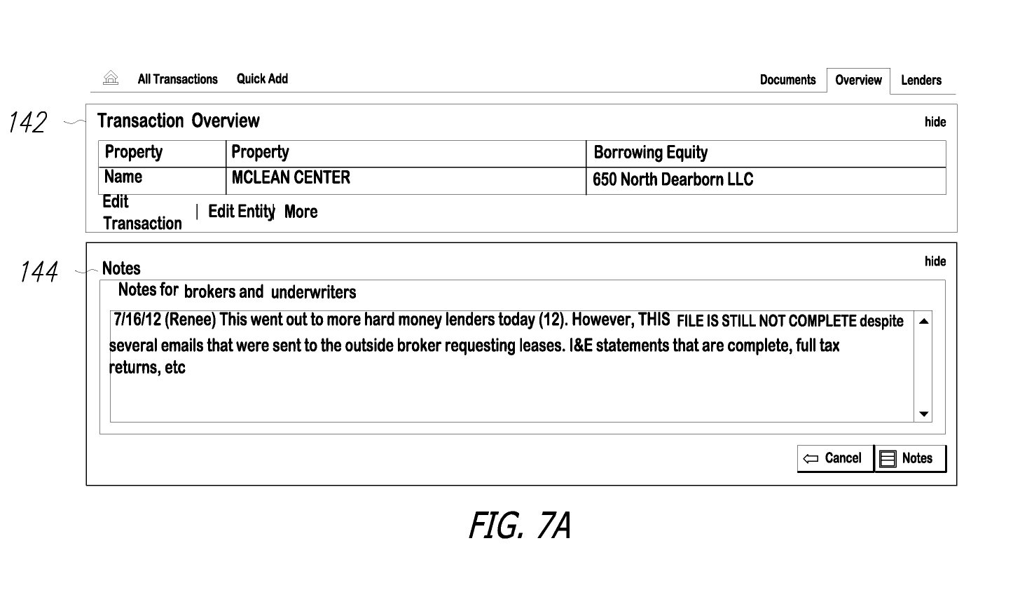

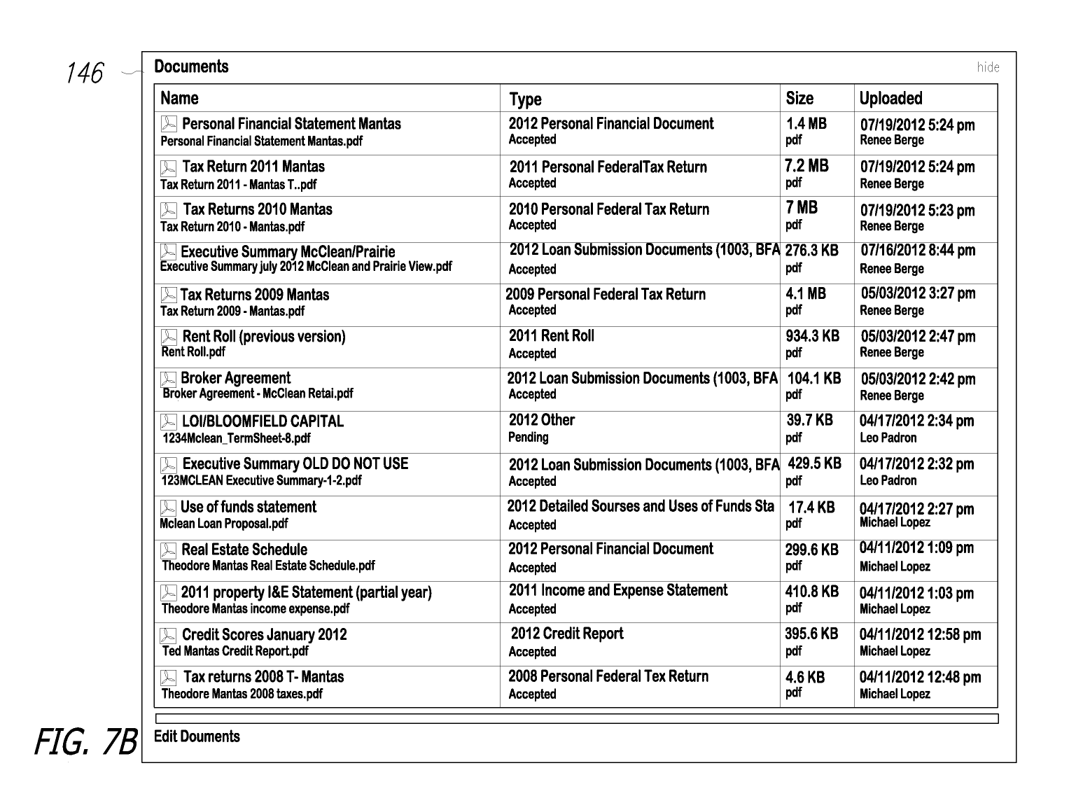

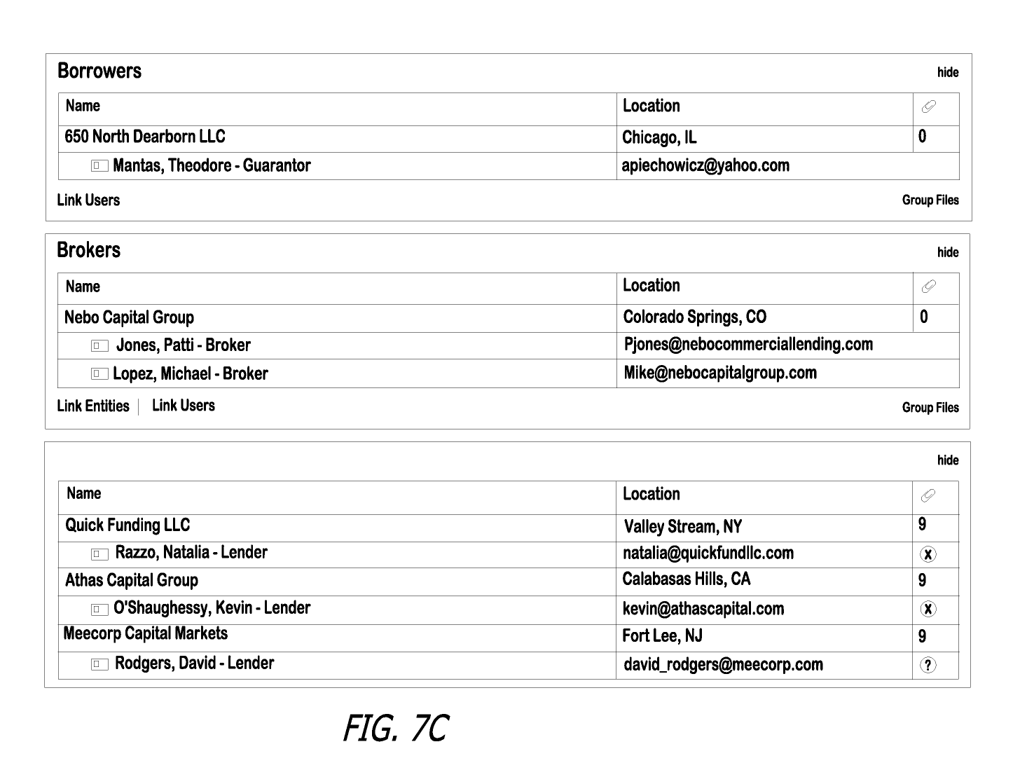

Upon selecting the “transaction” link, or otherwise selecting a transaction overview for a particular client and commercial real estate project, a “transaction overview” (142) window or screen is displayed to the user. The user in this case may be the borrower dealing directly with the lender, or more typically a broker or agent dealing directly with the finance program lender. It can be seen from FIG. 7 that the property type, name, borrowing entity are listed as part of the overview.

Electronic message notes are also presented in a window (144), which can be very helpful for those involved in the processing of the financing application to communicate with one another, instead of having to reach one another by telephone or send separate emails which are not connected whatsoever to a screen showing the particulars of the transaction. In fact, it can take a considerable amount of time for a broker or finance program representative to review separate telephonic messages and/or email messages and obtain the pertinent file and review the information in the file in conjunction with the message as is currently done. Enabling electronic message in a “notes” section, as illustrated in FIG. 7, eliminates this wasted time and frustration as the relevant parties can immediately view the electronic messages sent from and to one another as part of the transaction overview page. For example, the broker may inquire as to the status of the transaction by sending electronic message to the financing program representative. Similarly, a representative for the financing program can send an electronic message to the borrower or broker requesting additional information or documents, etc.

As illustrated in FIG. 7, the transaction overview page and windows typically includes a listing of the documents (146) which have previously been uploaded and are part of the application as well as borrower, broker and lender information, including contact information in the event that a telephone call or email message is required in order to contact the individual more rapidly.

It will be appreciated by those skilled in the art that the computerized system and method of the present invention provides many advantages to all parties involved in the commercial real estate loan application process than what is currently available and practiced. The borrower and/or broker is able to access and use a variety of analytics and tools to research the investment and financing. The present invention brings together both those seeking financing as well as those interested in providing capital in the form of loans or other financing vehicles at one convenient location. The borrower/broker can determine if the borrower and commercial real estate project prequalifies for various lenders and analyze cash flow, etc. The borrower/broker can create and upload documents listed by the finance program as being required for qualifying for that financing. The system of the present invention essentially walks a borrower or broker through the entire process of a commercial real estate loan application from preliminary information and analytics to prequalification to loan application and closing, all through the portal of the online platform/website. This results in a huge savings of time and money not yet realized in the commercial real estate brokerage industry.

Although several embodiments have been described in detail for purposes of illustration, various modifications may be made without departing from the scope and spirit of the invention. Accordingly, the invention is not to be limited, except as by the appended claims.

What is claimed is:

1. A computerized method facilitating qualification and acquisition of funding for commercial real estate projects, comprising the steps of:
using a computer to access a server hosted website;
inputting client data using the computer;
inputting commercial real estate project data using the computer;
accessing an electronic database of financing programs;
electronically determining pre-qualification of the client and commercial estate project to financing programs within the database;
electronically displaying at least one financing program for which the client pre-qualifies;
using the computer to select a pre-qualified financing program;
creating an electronic commercial real estate financing application; and
submitting the electronic commercial financing application to at least one of the pre-qualified financing programs.

2. The method of claim 1, the inputted commercial project data step includes the step of inputting property type, appraised value, purchase price, financing amount, and down payment data.

3. The method of claim 1, including the step of electronically displaying a plurality of commercial real estate financing types, and selecting a type of commercial real estate financing.

4. The method of claim 1, wherein the electronically determining pre-qualification step includes the step of comparing requirements of the financing programs to the inputted client and commercial project data.

5. The method of claim 1, wherein the displaying a listing of pre-qualified financing programs includes the step of electronically displaying financing rates and terms.

6. The method of claim 1, wherein the creating the electronic financing application step includes the step of inputting commercial financing application data into an electronic template window.

7. The method of claim 6, wherein commercial financing application data comprises commercial property data, borrower data, and financial data.

8. The method of claim 1, including the step of electronically uploading financial documents to accompany the financing application and electronically saving the uploaded documents.

9. The method of claim 8, including the step of making available for downloading or viewing the uploaded documents by a finance program representative or a broker or underwriter.

10. The method of claim 1, including the step of the client selecting to:
submit the financing application directly to a selected finance program;
use a website representative to serve as a broker or underwriter to submit and process the financing application with the selected finance program; or
use a third party broker or underwriter to submit and process the financing application with the selected finance program.

11. The method of claim 1, including the step of electronically displaying a transaction status page or window, including information relating to the status of each submitted commercial financing application.

12. The method of claim 11, including the step of displaying finance program name, finance program contact information, finance program geographic location, transaction status, and financing application start date.

13. The method of claim 12, wherein the transaction status information is viewable by the client, broker and/or finance program representative.

14. The method of claim 1, including the step of displaying electronically generated messages related to the financing application generated by the client, broker and/or finance program representative.

15. The method of claim 8, including the step of prompting the client or broker to upload particular documents required for the commercial financing application.

16. The method of claim 1, including the step of electronically displaying a transaction overview page or window, including borrower data, commercial property data, electronic messages generated by the client, broker or finance program representative, electronic financing application, uploaded and electronically saved documents, and finance program data.

17. A computerized method facilitating qualification and acquisition of funding for commercial real estate projects, comprising the steps of:
using a computer to access a server hosted website;
inputting client data using the computer;
inputting commercial real estate project data using the computer, including property type, appraised value, purchase price, financing amount, and down payment data;
accessing an electronic database of financing programs;
electronically determining pre-qualification of the client and commercial estate project to financing programs within the database, including comparing requirements of the financing programs to the inputted client and commercial project data;
electronically displaying at least one financing program for which the client pre-qualifies, including listing financing rates and terms for each pre-qualified financing program;
using the computer to select a pre-qualified financing program;
creating an electronic commercial real estate financing application, including inputting commercial financing application data comprising commercial property data, borrower data, and financial data into an electronic template of the financing application;
prompting the client or broker to upload particular documents required for the commercial financing application;
electronically uploading financial documents to accompany the financing application and electronically saving the uploaded documents;
making available for downloading or viewing the uploaded documents by a finance program representative or a broker or underwriter; and
submitting the electronic commercial financing application to at least one of the pre-qualified financing programs.

18. The method of claim 17, including the step of electronically displaying a plurality of commercial real estate financing types, and selecting a type of commercial real estate financing.

19. The method of claim 17, including the step of the client selecting to:
submit the financing application directly to a selected finance program;
use a website representative to serve as a broker or underwriter to submit and process the financing application with the selected finance program; or
use a third party broker or underwriter to submit and process the financing application with the selected finance program.

20. The method of claim 17, including the step of electronically displaying a transaction status page or window, including information relating to the status of each submitted commercial financing application, including the step of displaying finance program name, finance program contact information, finance program geographic location, transaction status, and financing application start date, wherein the transaction status information is viewable by the client, broker and/or finance program representative.

21. The method of claim 17, including the step of displaying electronically generated messages related to the financing application generated by the client, broker and/or finance program representative.

22. The method of claim 17, including the step of electronically displaying a transaction overview page or window, including borrower data, commercial property data, electronic messages generated by the client, broker or finance program representative, electronic financing application, uploaded and electronically saved documents, and finance program data.
